(19) United States
(12) Patent Application Publication
(10) Pub. No.: US 2006/0143374 A1
(43) Pub. Date: Jun. 29, 2006

(54) Pipelined look-up in a content addressable memory

(76) Inventors: Sailesh Kottapalli, San Jose, CA (US); Udo Walterscheidt, San Jose, CA (US); Michael J. Reitsma, Burlingame, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,636

(22) Filed: Dec. 29, 2004

(51) Int. Cl. G06F 12/00

(52) U.S. Cl. 711/108

(57) ABSTRACT

A pipelined look-up in a content addressable memory disclosed. In one embodiment, a content addressable memory includes a first cell and a second cell. The first cell is to compare a first bit of look-up data to a first bit of stored data. The second cell is to compare a second bit of look-up data to a second bit of stored data, and to generate a signal to disable the first cell if the second bit of look-up data does not match the second bit of stored data.

### BACKGROUND

1. Field

The present disclosure pertains to the field of data processing and, more specifically, to the field of content addressable memories (“CAMs”) in microprocessors and other data processing apparatuses.

2. Description of Related Art

CAMs are used in applications where entries are identified, or “looked-up,” based on their contents instead of their addresses. These applications include translation look-aside buffers, fully associative caches, and data dependency checking for out-of-order instruction scheduling.

In a typical configuration, CAM look-ups are implemented in dynamic logic. A match to a CAM entry is indicated by a logical high state on a hit line that is pre-charged high in one phase of the clock, and conditionally discharged by one or more CAM cells in the other phase. Each CAM cell corresponds to one bit of one CAM entry, and includes a pull-down transistor controlled by a comparator. The comparator turns the pull-down transistor on when the CAM entry bit does not match the corresponding look-up bit.

In this typical configuration, every cell of every entry must be checked on a look-up. However, in most applications where CAMs are used, there are only a few matches per look-up, usually no more than one. Therefore, almost every CAM look-up requires charging an aggregate load proportional to the number of entries times the number of bits per entry, and discharging virtually the entire load. Consequently, CAMs may account for a significant portion of the power consumed by high performance microprocessors.

### BRIEF DESCRIPTION OF THE FIGURES

The present invention is illustrated by way of example and not limitation in the accompanying figures.

FIG. 1 illustrates an embodiment of a CAM having a pipelined look-up.

FIG. 2 illustrates an entry location in the CAM of FIG. 1 in greater detail.

FIG. 3 illustrates a cell in the CAM of FIG. 1 in greater detail.

FIG. 4 illustrates a method for performing a pipelined CAM look-up.

FIG. 5 illustrates an embodiment of a system having a pipelined CAM look-up.

### DETAILED DESCRIPTION

The following description describes embodiments of techniques for pipelining the look-up in a CAM. Pipelining the look-up in a CAM may be desirable in order to reduce the dynamic power consumption of the CAM. In a typical non-pipelined CAM, every cell of every entry must be checked on a look-up. Embodiments of the present invention may provide CAMs is which only a fraction of the cells must be checked on a look-up, where the fraction depends on the depth of the pipeline, the distribution of the match content in the CAM (e.g., an even distribution of ones and zeroes throughout the CAM, a random distribution, or a clustered distribution), and other factors. Therefore, the dynamic power consumption may be reduced by approximately the fraction of cells that are not checked.

Accordingly, various embodiments of the present invention may be used for various applications, and the details of each embodiments may be chosen based on the factors that determine or may be used to predict the fraction of cells that must be checked per look-up, plus the amount of power consumed by the pipelining elements, balanced against the performance requirements of the CAM.

In the following description, numerous specific details, such as logic and circuit configurations, are set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

Embodiments of the present invention provide techniques for pipelining the look-up in a CAM, and may be applied to any CAM used in any application, including translation look-aside buffers, fully associative caches, and data dependency checking for out-of-order instruction scheduling. Accordingly, the data stored in a CAM using these techniques may be any type of information, including memory addresses, represented by binary digits or in any other form. A CAM using these techniques may have any number of entries and any number of bits per entry, and may be functionally organized according to any known approach. For example, the CAM may be organized into two sections, one for match content and one for payload content, where the match content is the data to be compared to the data presented to the CAM for look-up (the “look-up data”), and the payload content is the data to be delivered if there is a hit to the corresponding match content. Alternatively, the CAM may have no payload section, and instead be organized to deliver the match content itself, or simply an indicator of whether or not there is a match.

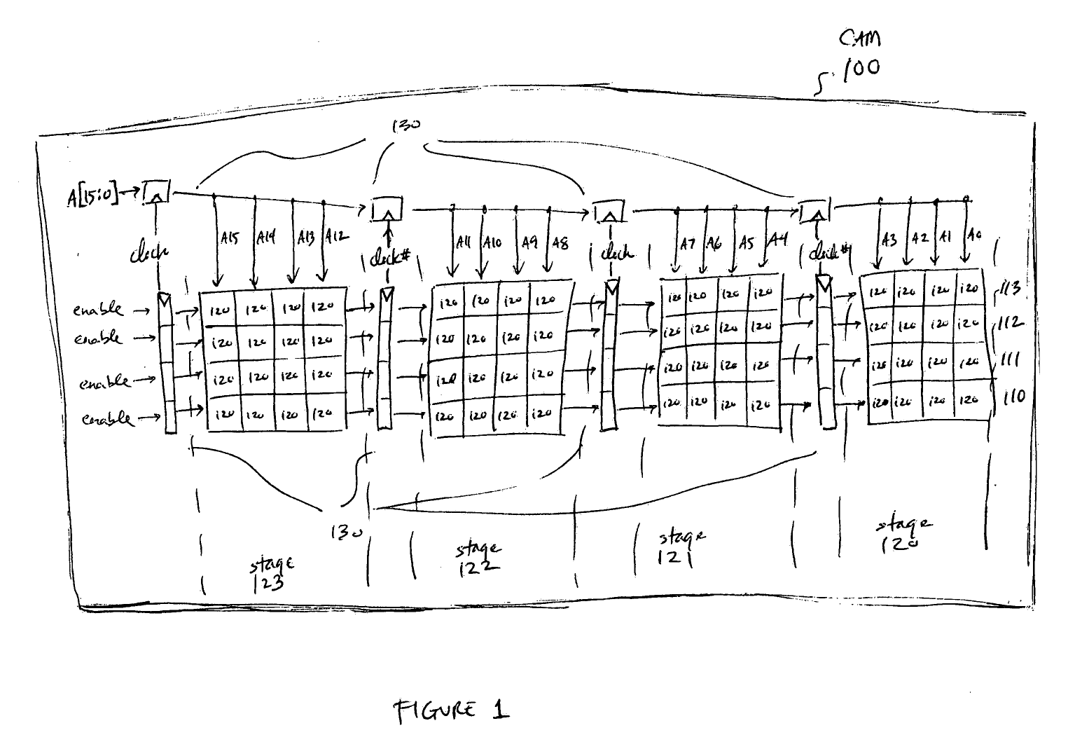

FIG. 1 illustrates an embodiment of a CAM 100 having a pipelined look-up. CAM 100 includes entry locations 113, 112, 111, and 110, each having sixteen CAM cells 120 to store sixteen bits of match content per entry location. Using flip-flops 130, CAM 100 is pipelined into stages 123, 122 121, and 120, such that a comparison of the look-up data to the contents of each entry location is performed in stages. Any type of latch, flip-flop, or other memory element used in the design of sequential circuits may be used instead of flip-flops 130, and they may be clocked in any manner used in the design of sequential circuit, for example, they may be clocked such that the latency of each pipeline stage is a full clock period, or alternatively, a half clock period.

In stage 123, bits 15 to 12 of the look-up data are compared to bits 15 to 12 of each entry, and one result per entry is passed to stage 122. In stage 122, bits 11 to 8 of the look-up data are compared to bits 11 to 8 of each entry, and one result per entry, indicating whether bits 15 to 8 of the look-up data match bits 15 to 8 of the entry, are passed to stage 121. In stage 121, bits 7 to 4 of the look-up data are compared to bits 7 to 4 of each entry, and one result per entry, indicating whether bits 15 to 4 of the look-up data match bits 15 to 4 of the entry, are passed to stage 120. In stage 120, bits 3 to 0 of the look-up data are compared to bits 3 to 0 of each entry, and one result per entry indicates whether the full sixteen bits of look-up data match the full sixteen bits of the entry. The stages are pipelined such that for each entry, the comparison is enabled in each stage only if there is a match in all prior stages for that entry.

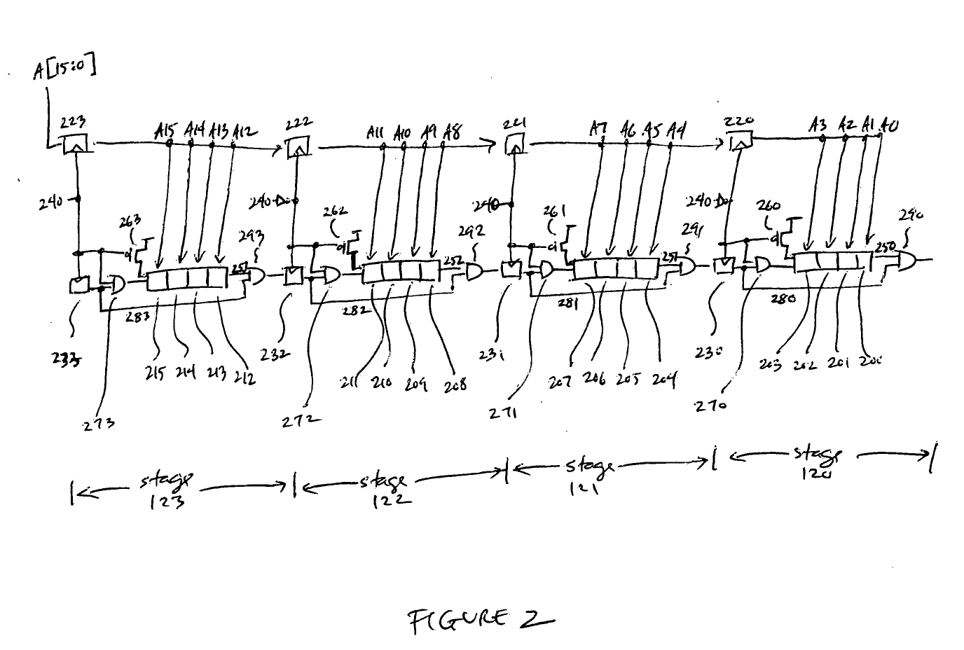

FIG. 2 illustrates entry location 110 of CAM 100 in greater detail. Entry location 110 includes cells 215, 214, 213, and 212 in stage 123, cells 211, 210, 209, and 208 in stage 122, cells 207, 206, 205, and 204 in stage 121, and cells 203, 202, 201, and 200 in stage 120. Edge-triggered flip-flops 223, 221, 233, and 231 are clocked with clock signal 240, and edge-triggered flip-flops 222, 220, 232, and 230 are clocked with the complement of clock signal 240, so as to pipeline the flow of signals through stages 123 to 120.

Flip-flop 223 receives sixteen bits look-up data 241, passes bit 15 to cell 215, bit 14 to cell 214, bit 13 to cell 213, bit 12 to cell 212, and bits 11 to 0 to flip-flop 222. Flip-flop 222 passes bit 11 to cell 211, bit 10 to cell 210, bit 9 to cell 209, bit 8 to cell 208, and bits 7 to 0 to flip-flop 221. Flip-flop 221 passes bit 7 to cell 207, bit 6 to cell 206, bit 5 to cell 205, bit 4 to cell 204, and bits 3 to 0 to flip-flop 220. Flip-flop 220 passes bit 3 to cell 203, bit 2 to cell 202, bit 1 to cell 201, and bit 0 to cell 200.

Hit lines 253 and 251 are precharged high by PMOS pull-up transistors 263 and 261, respectively, when clock signal 240 is low, and hit lines 252 and 250 are precharged high by PMOS pull-up transistors 262 and 260, respectively, when clock signal 240 is high. AND gates 273 and 271 gate enable lines 283 and 281 with clock signal 240, and AND gates 272 and 270 gate enable lines 282 and 280 with the complement of clock signal 240, so that the look-up logic in each cell is not enabled when the cell is being precharged.

Enable line 283 may be used to carry a signal indicating that the entry in entry location 110 is valid, so that the look-up logic in cells 215 through 212 is not enabled if the entry is not valid. The entry valid signal on enable line 283 is forwarded to AND gate 293 to gate the signal on hit line 253, so that the look-up logic in cells 211 through 208 is not enabled unless the entry is valid and bits 15 through 12 of look-up data 241 matches the contents of cells 215 through 212. The signal on enable line 282 is forwarded to AND gate 292 to gate the signal on hit line 252, so that the look-up logic in cells 207 through 204 is not enabled unless the entry is valid and bits 15 through 8 of look-up data 241 matches the contents of cells 215 through 208. The signal on enable line 281 is forwarded to AND gate 291 to gate the signal on hit line 251, so that the look-up logic in cells 203 through 200 is not enabled unless the entry is valid and bits 15 through 4 of look-up data 241 matches the contents of cells 215 through 204. The signal on enable line 280 is forwarded to AND gate 290 to gate the signal on hit line 250, so that the output signal is asserted only if the entry is valid and bits 15 through 0 of look-up data 241 matches the contents of cells 215 through 200.

In this way, the hit signal from each stage represents the accumulated hit signals from the previous stages, where the hit signal from the first stage is asserted only if the entry is valid. This accumulated hit signal may be used to enable the look-up logic in the subsequent stage. Therefore, an entry location's look-up logic in stages 122, 121, and 120 will consume dynamic power only if there has been a hit to that entry in all of the previous stages and the entry is valid.

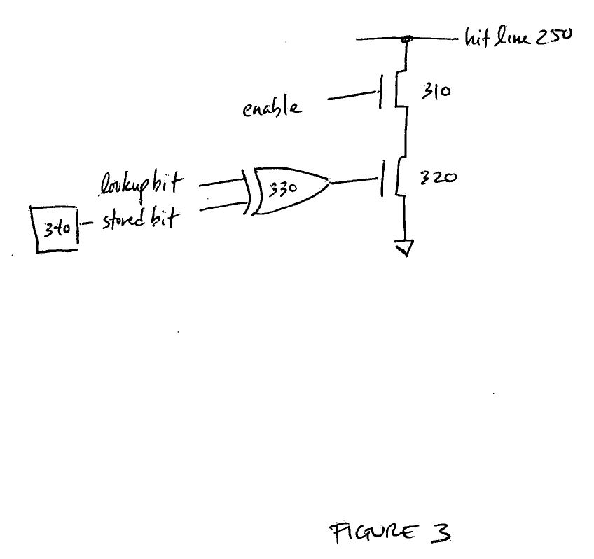

FIG. 3 illustrates the look-up logic of cell 200 of FIG. 2 in greater detail. NMOS pull-down transistors 310 and 320 are connected in series to hit line 250. The gate of pull-down transistor 310 is connected to the clock gated version of the enable signal from enable line 281, and the gate of pull-down transistor 320 is connected to the output of XOR gate 330. Therefore, hit line 250 is discharged only if the look-up logic of cell 200 is enabled and bit 0 of look-up data 241 matches the bit of data stored in memory element 340 of cell 200.

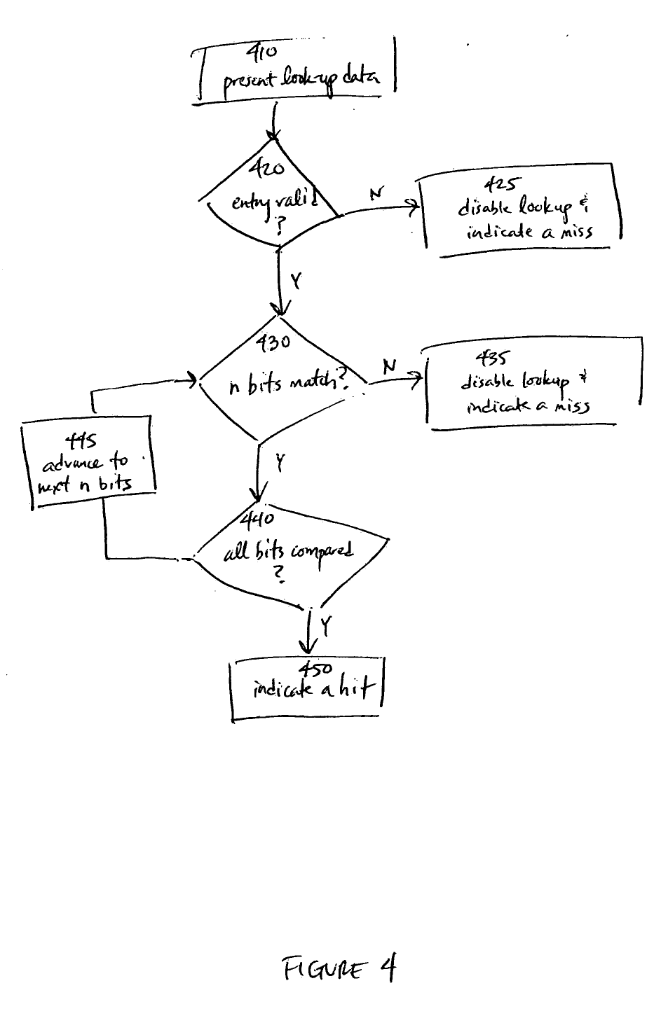

FIG. 4 is a flowchart illustrating an embodiment of a method for performing a pipelined CAM look-up. In block 410, look-up data is presented to the CAM. In block 420, an indicator of whether a CAM entry is valid is checked. If the entry is not valid, then, in block 425, the look-up logic is disabled and a miss to the entry location is indicated. If the entry is valid, then, in block 430, n bits of look-up data is compared to n bits of the CAM entry, where n is less than the total number of bits in the entry. If the bits do not match, then, in block 435, the remainder of the look-up logic is disabled and a miss to the entry is indicated, by discharging a hit line or otherwise. If the bits do match, then, block 440 represents a determination of whether all of the bits of look-up data have been compared. If so, then, in block 450, a hit to the CAM entry is indicated. If not, then, in block 445, the look-up is advanced to the next n bits of look-up data and the next n bits of the CAM entry, then flow returns to block 430 for a comparison.

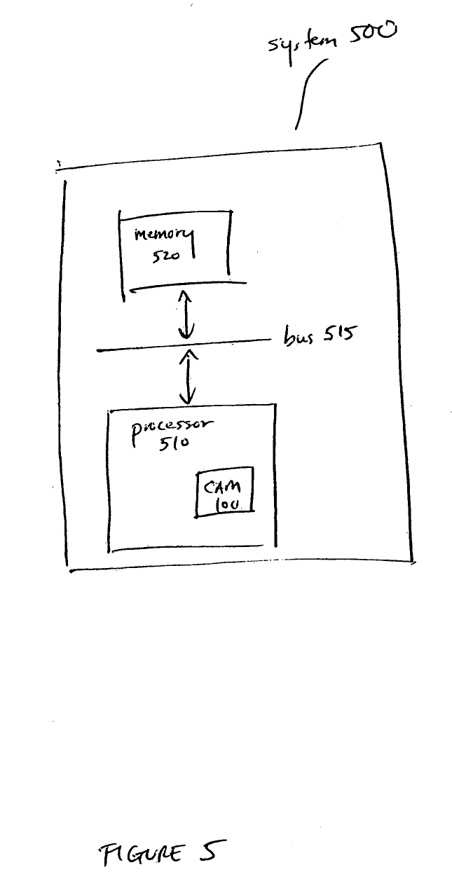

FIG. 5 illustrates an embodiment of a system 500 having a pipelined CAM look-up. System 500 includes processor 510, which includes CAM 100 or any other CAM in accordance with the present invention. Processor 510 may be any of a variety of different types of processors that include a CAM for any application. For example, the processor may be a general purpose processor such as a processor in the Pentium® Processor Family, the Itanium® Processor Family, or other processor family from Intel Corporation, or another processor from another company.

System 500 also includes memory 520 coupled to processor 510 through bus 515, or through any other buses or components. Memory 520 may be any type of memory capable of storing data to be operated on by processor 510, such as static or dynamic random access memory, semiconductor-based read only memory, or a magnetic or optical disk memory. Look-up data to be compared to data stored in CAM 100 may be stored in memory 520 or may represent an address of data in memory 520. System 500 may include any other buses or components in addition to processor 510, bus 515, and memory 520.

Processor 510, or any other processor or component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for pipelining a CAM look-up have been disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

For example, although FIGS. 1 and 2 illustrate a CAM, having four entries and four bits per entry, pipelined into four stages, any CAM with any number of entries or bits per entry may be pipelined into any number of stages within the scope of the present invention. In another embodiment, in a fully associative translation look-aside buffer with 256 entry locations, supporting 64-bit virtual addressing with a minimum page size of 4 kilobytes, the CAM look-up of bits 63 through 12 of the virtual address may be pipelined into four stages of thirteen bits each.

In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A content addressable memory comprising:
a first cell to compare a first bit of look-up data to a first bit of stored data; and
a second cell to compare a second bit of look-up data to a second bit of stored data and to generate a signal to disable the first cell if the second bit of look-up data does not match the second bit of stored data.

2. The content addressable memory of claim 1, wherein the second cell is to compare before a transition of a clock signal and the first cell is to compare after the transition of the clock signal.

3. A content addressable memory of claim 1, further comprising a third cell to compare a third bit of look-up data to a third bit of stored data and to generate a signal to disable the first cell and the second cell if the third bit of look-up data does not match the third bit of stored data.

4. A content addressable memory comprising:
a plurality of entry locations, each entry location including:
a first plurality of cells having first comparison logic to assert a first hit signal if a first portion of stored data matches a first portion of look-up data before a transition of a clock signal; and
a second plurality of cells having second comparison logic to assert a second hit signal if the first hit signal is asserted and a second portion of stored data matches a second portion of look-up data after the transition of the clock signal, wherein the second comparison logic is disabled if the first hit signal is not asserted.

5. A method comprising:
comparing a first plurality of bits of look-up data to a first plurality of bits of data stored in an entry location in a content addressable memory; and
disabling a comparison of a second plurality of bits of look-up data to a second plurality of bits stored in the entry location if the first plurality of bits of look-up data does not match the first plurality of bits of data stored in the entry location.

6. A system comprising:
a dynamic random access memory; and
a processor including a content addressable memory having:
a first cell to compare a first bit of look-up data to a first bit of stored data; and
a second cell to compare a second bit of look-up data to a second bit of stored data and to generate a signal to disable the first cell if the second bit of look-up data does not match the second bit of stored data.
